(19) United States
(12) Patent Application Publication
(10) Pub. No.: US 2013/0170225 A1
(43) Pub. Date: Jul. 4, 2013

(54) CONVERGING LENS WITH MULTIPLE-CURVATURE COMPOUND SURFACE, CONCENTRATOR MODULE AND LIGHTING FIXTURE HAVING THE SAME

(71) Applicant: KUO-CHIN HUANG, TAINAN (TW)

(72) Inventor: KUO-CHIN HUANG, TAINAN (TW)

(21) Appl. No.: 13/339,642

(22) Filed: Dec. 29, 2011

(51) Int. Cl. F21V 5/04

(52) U.S. Cl. 362/311.06; 362/335

(57) ABSTRACT

A converging lens with a multiple-curvature compound surface is revealed. The converging lens includes an incident surface and an emission surface. A crest-line along X axis and a crest-line along Y axis are on the emission surface, crossed each other and dividing the emission surface into four curved surface sections. The X-axis curvature as well as the Y-axis curvature of each curved surface section can be the same or different. An angle θ between the crest-line along X axis and the X-axis ranges from 0˜30 degrees. Thereby light from a light sources passes through the converging lens and projects to produce a light pattern required. The converging lens is used in concentrator modules and lighting fixtures.

### BACKGROUND OF THE INVENTION

1. Fields of the Invention

The present invention relates to a converging lens with a multiple-curvature compound surface, a concentrator module and a lighting fixture having the same, especially to a converging lens that generates light patterns and light intensity users required by a design of a multiple-curvature compound surface. The converging lens is used in concentrator modules and lighting fixtures.

2. Descriptions of Related Art

The lighting devices of automobiles and motorcycles are getting to have stronger function, longer use time, more power and energy saving, smaller volume and easier design of vehicle lights' appearance.

### SUMMARY OF THE INVENTION

Therefore it is a primary object of the present invention to provide a converging lens with a multiple-curvature compound surface in which a light beams with light patterns and light intensity that meet lighting requirements is generated by a design of the multiple-curvature compound surface.

It is another object of the present invention to provide a converging lens with a multiple-curvature compound surface that is used together with a point light source to form a concentrator module.

It is a further object of the present invention to provide a converging lens with a multiple-curvature compound surface that is assembled with a point light source, a substrate and a light-transmissive cover to form a lighting fixture.

In order to achieve above objects, a converging lens with a multiple-curvature compound surface of the present invention includes an incident surface and an emission surface. The incident surface is defined as a surface of the converging lens that light from a point light source enters the converging lens while the emission surface is defined as a surface of the converging lens that the light leaves the converging lens. The emission surface is disposed with a crest-line along X axis and a crest-line along Y axis, crossed each other and dividing the emission surface into four curved surface sections turning in a clockwise direction-from a first curved surface section to a fourth curved surface section. Any two points of the crest-line along X axis have the same Y-axis curvature and any two points of the crest-line along Y axis have the same X-axis curvature. The X-axis curvature as well as the Y-axis curvature of each curved surface section can be the same or different from one another. Moreover, part of the crest-line along X axis is between the first and the second curved surface sections while the rest part of the crest-line along X axis is between the third and the fourth curved surface sections. An angle θ between the two parts of the crest-line along X axis and the X-axis ranges from 0 degree to 30 degrees. Thereby light from the point light source passes through the converging lens and projects a preset light pattern.

In order to achieve above objects, a concentrator module of the present invention consists of at least one point light source and an above-mentioned converging lens with a multiple-curvature compound surface. The point light source is located on one side of the converging lens having the incident surface.

In order to achieve above objects, a lighting fixture of the present invention is composed of at least one concentrator module, a substrate for mounting the concentrator module, and a light-transmissive cover disposed on the side of the concentrator module with the emission surface and the light-transmissive cover is connected to the substrate.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment of a converging lens according to the present invention;

FIG. 2 is a front view of an embodiment of a converging lens according to the present invention;

FIG. 3 is a top view of an embodiment of a converging lens according to the present invention;

FIG. 4 is a side view of an embodiment of a converging lens according to the present invention;

FIG. 5 is a front view of another embodiment of a converging lens according to the present invention;

FIG. 6 is a schematic drawing showing a preset light pattern formed by light emitted from a point light source, passing through an embodiment of a converging lens and projecting onto a direction perpendicular to the light emitting direction;

FIG. 7 is a schematic drawing showing a light pattern formed by light projected from an embodiment of a converging lens according to the present invention;

FIG. 8 is a schematic drawing showing another light pattern formed by light projected from an embodiment of a converging lens according to the present invention;

FIG. 9 is a schematic drawing showing a further light pattern formed by light projected from an embodiment of a converging lens according to the present invention;

FIG. 10 is a schematic drawing showing a further light pattern formed by light projected from an embodiment of a converging lens according to the present invention;

FIG. 11 is a schematic drawing showing an embodiment of a converging lens according to the present invention applied to a concentrator module;

FIG. 12 is a schematic drawing showing an embodiment of a concentrator module according to the present invention used in a light fixture.

### DETAILED DESCRIPTION OF THE PREFERRED EMBODIMENT

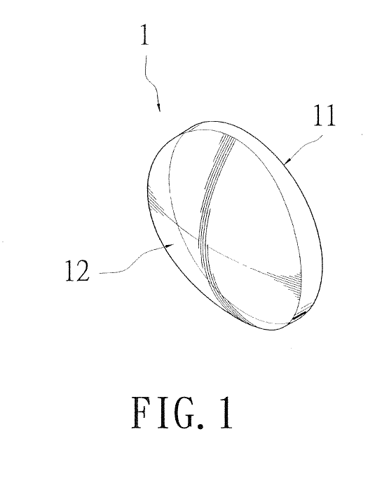

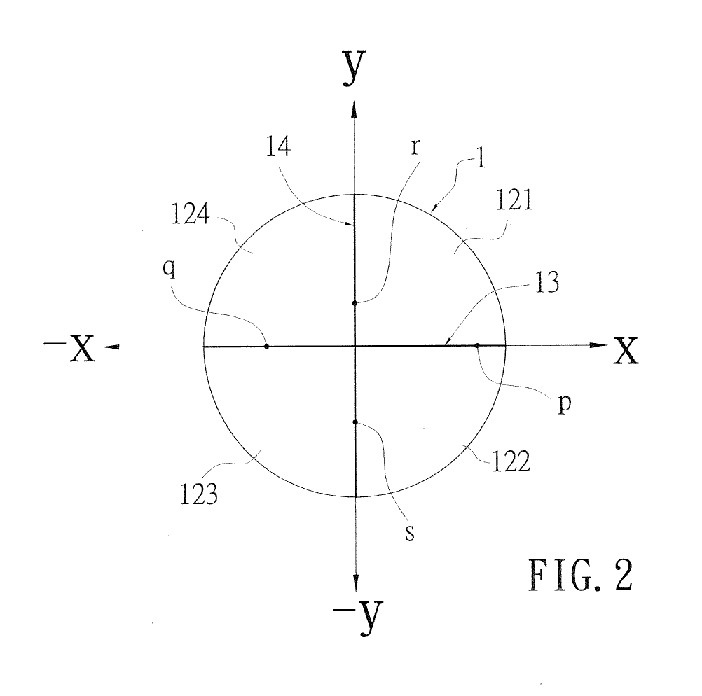

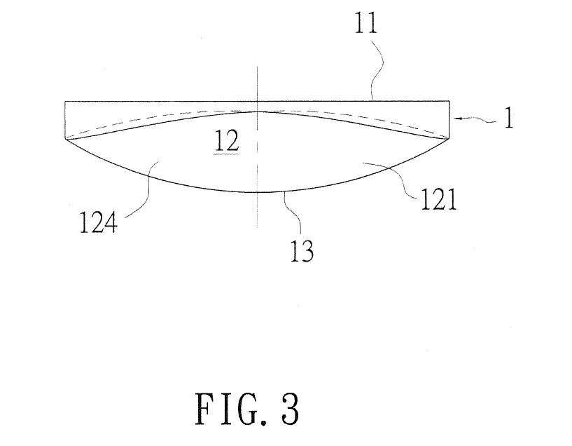

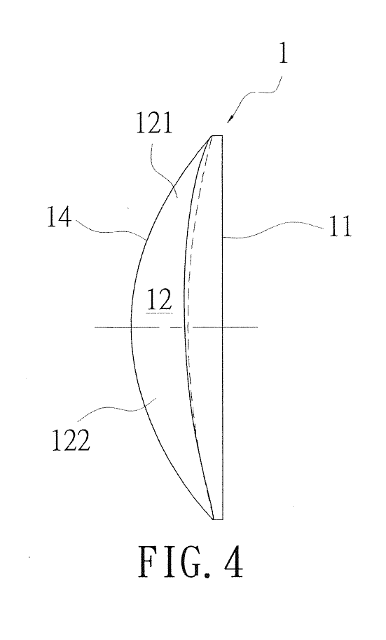

Refer to FIG. 1, an embodiment of a converging lens with a multiple-curvature compound surface is revealed. A converging lens 1 with a multiple-curvature compound surface includes an incident surface 11 and an emission surface 12. The incident surface 11 is defined as a surface of the converging lens 1 that light from a point light source enters the converging lens 1 while a surface of the converging lens 1 that the light leaves the converging lens 1 is defined as the emission surface 12. Refer from FIG. 2 to FIG. 4, the emission surface 12 is arranged with a crest-line along X axis 13 and a crest-line along Y axis 14, crossed each other. The crossed crest-line along X axis 13 and the crest-line along Y axis 14 divide the emission surface 12 into four curved surface sections-from a first curved surface section to a fourth curved surface section 121, 122, 123, 124 turning in a clockwise direction. The first and the second curved surface sections 121, 122 intersect at the crest-line along X axis 13, the first and the fourth curved surface sections 121,124 intersect at the crest-line along Y axis 14, the second and the third curved surface sections 122, 123 intersect at the crest-line along Y axis 14, and the third and the fourth curved surface sections 123, 124 intersect at the crest-line along X axis 13. Moreover, any two points of the crest-line along X axis 13, p, q, have the same Y-axis curvature (Y_{K}), [symbol] X_{pK}=X_{qK} [symbol] and any two points of the crest-line along Y axis 14, r, s, have the same X-axis curvature (X_{K}), [symbol] Xᵣₖ=X_{sK} [symbol] . The X-axis curvature (X_{1˜4K}) of each curved surface section 121˜124 may be the same or different. Similarly, the Y-axis curvature (Y_{1˜4K}) of each curved surface section 121˜124 may be the same or different.

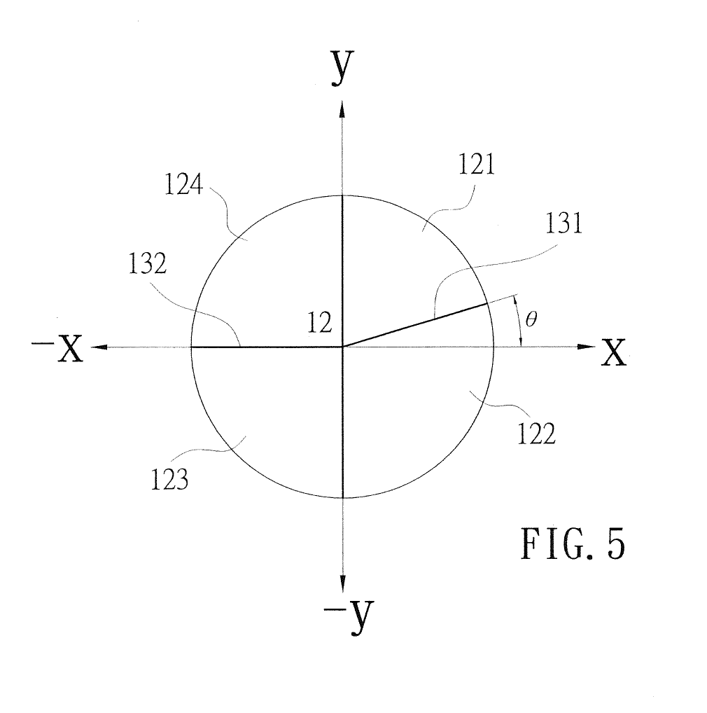

Refer to FIG. 5, another embodiment of a converging lens 1 according to the present invention is revealed. In this embodiment, there is an angle θ between a crest-line along X axis 131 and the X-axis (or between a crest-line along X axis 132 and the X-axis). The crest-line along X axis 131 is between the first and the second curved surface sections 121, 122 while the crest-line along X axis 132 is between the third and the fourth curved surface sections 123, 124. The angle θ ranges from 0 degree to 30 degrees.

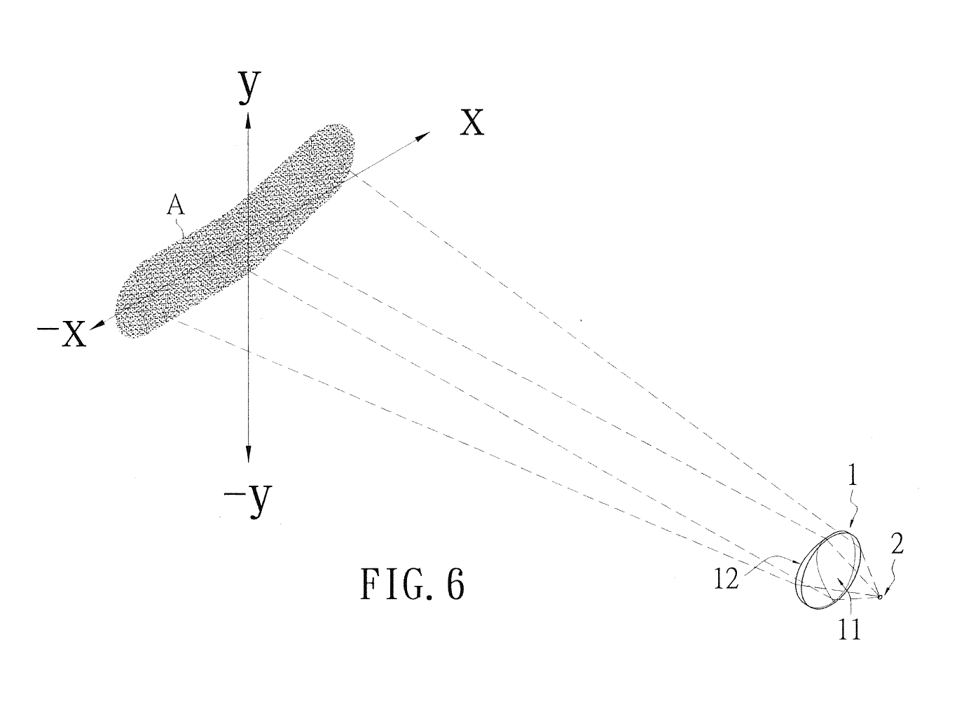

Refer to FIG. 5 and FIG. 6, a point light source 2 is set on one side of the converging lens 1 having the incident surface 11. When the point light source 2 emits light, the light passes through the emission surface 12 of the converging lens 1, which is a multiple-curvature compound surface, to form a light beam whose cross section along the direction perpendicular to the light emitting direction is with a preset shape A.

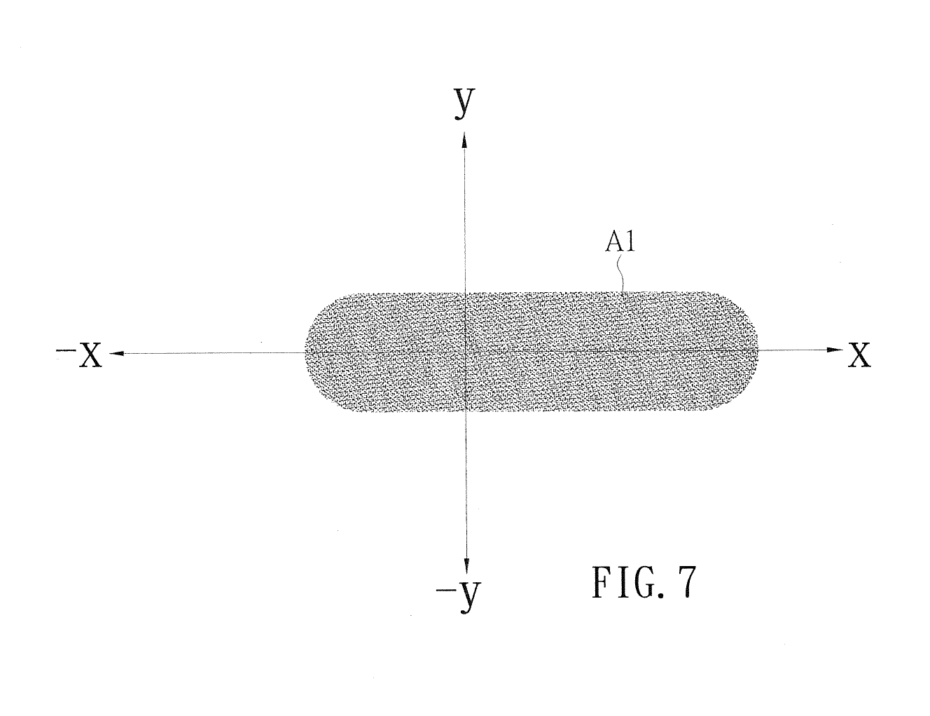

Refer to FIG. 7, a cross sectional shape A1 of the light beam formed by the light emitted from the point light source 2 passing through the converging lens 1 and projecting out of the converging lens 1 is revealed. In this cross sectional shape A1 the X-axis curvature (X₁ [symbol] _{2K}) of the first and the second curved surface sections 121, 122 is larger than the X-axis curvature (X₃ [symbol] _{4K}) of the third and the fourth curved surface sections 123, 124 while the Y-axis curvature (Y_{1˜4K}) of each curved surface section 121˜124 is the same. A crest-line along X axis 131 is between the first and the second curved surface sections 121, 122 while a crest-line along X axis 132 is between the third and the fourth curved surface sections 123, 124.

An angle θ between the crest-line along X axis 131 and the X-axis is zero, and so is an angle θ between the crest-line along X axis 132 and the X-axis. Thus a light pattern is generated according to the above conditions.

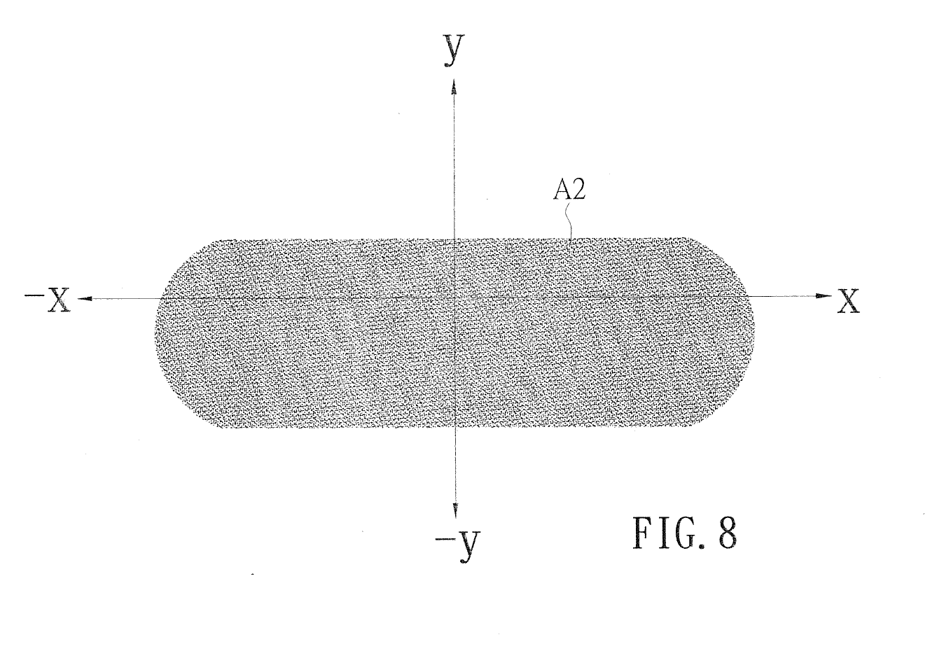

Refer to FIG. 8, in this light pattern, the X-axis curvature (X_{1˜4K}) of each curved surface sections 121˜124 on the emission surface 12 of the converging lens 1 is the same while the Y-axis curvature (Y₁ [symbol] _{4K}) of the first and the fourth curved surface sections 121, 124 is smaller than the Y-axis curvature (Y₂ [symbol] _{3K}) of the second and the third curved surface sections 122, 123. A crest-line along X axis 131 is between the first and the second curved surface sections 121, 122 while a crest-line along X axis 132 is between the third and the fourth curved surface sections 123, 124. An angle θ between the crest-line along X axis 131 and the X-axis is zero, and so is the angle θ between the crest-line along X axis 132 and the X-axis. In accordance with above conditions, light emitted from the point light source 2 passes through and projects out of the converging lens 1 to form a light beam with a cross sectional shape A2.

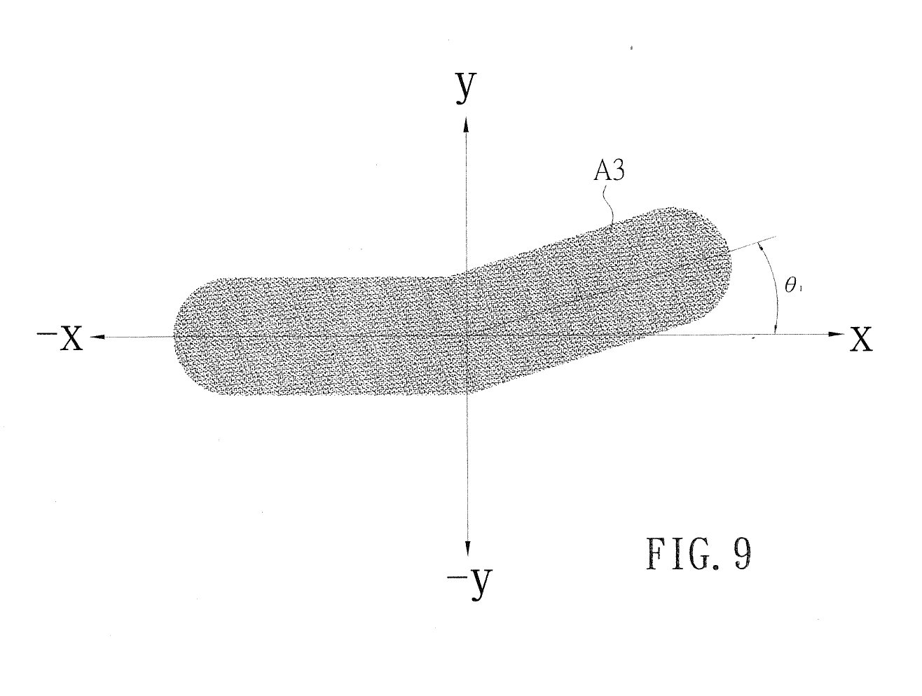

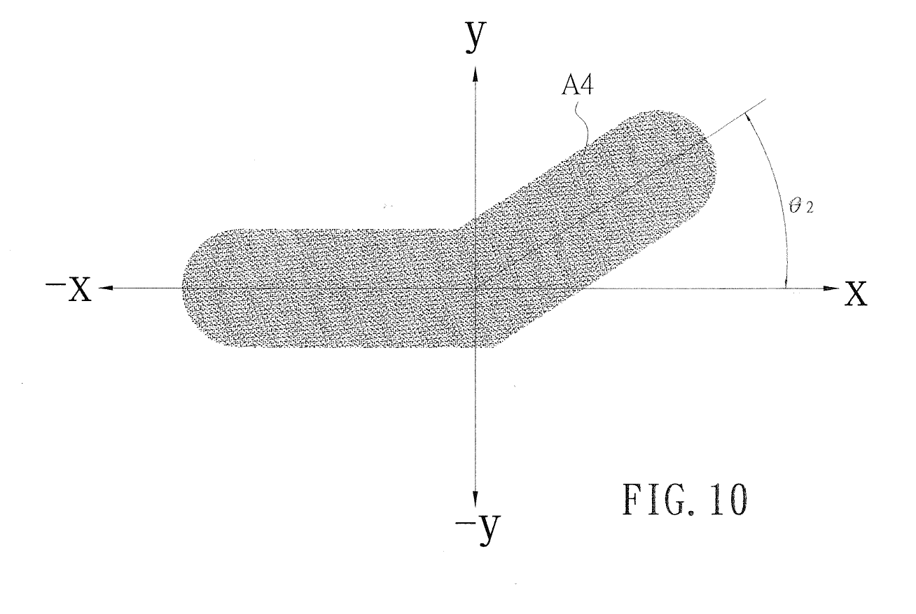

Refer to FIG. 9 and FIG. 10, a cross sectional shape A3 and a cross sectional shape A4 of a light beam formed by the light emitted from the point light source 2 passing through the converging lens 1 and projecting out of the converging lens 1 are revealed. The X-axis curvature (X_{1˜4K}) of each curved surface sections 121˜124 on the emission surface 12 of the converging lens 1 is the same while the Y-axis curvature while the Y-axis curvature (Y_{1˜4K}) of each curved surface sections 121˜124 is also the same as one another. A crest-line along X axis 131 is between the first and the second curved surface sections 121, 122 while a crest-line along X axis 132 is between the third and the fourth curved surface sections 123, 124. An angle θ between the crest-line along X axis 131 and the X-axis is larger than zero while an angle θ between the crest-line along X axis 132 and the X-axis is zero. An angle θ1 shown in FIG. 9 is smaller than an angle θ2 shown in FIG. 10. The angle θ1 shown in FIG. 9 is 17 degrees and the angle θ2 shown in FIG. 10 is 30 degrees.

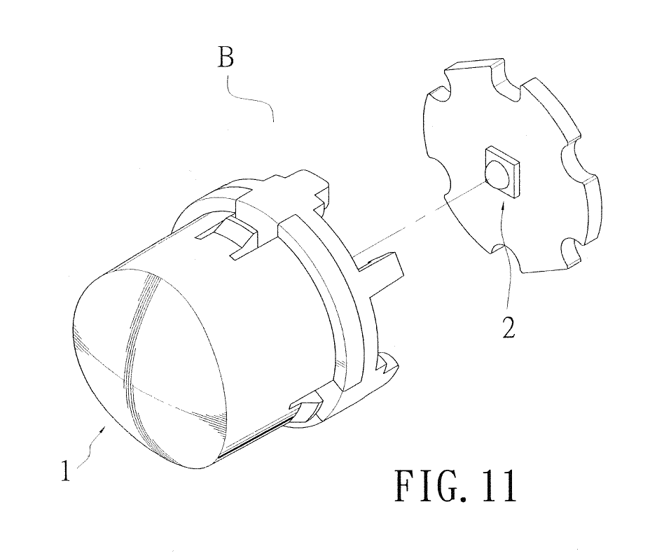

Refer to FIG. 11, a schematic drawing showing a converging lens 1 of the present invention applied to a concentrator module B. The concentrator module I includes a converging lens 1 and a point light source 2 arranged corresponding to an incident surface 11 of the converging lens 1. When the point light source 2 is driven to emit light, the light from the point light source 2 passes through the converging lens 1 and projects out to generate a preset light pattern located on a cross section perpendicular to the light emitting direction.

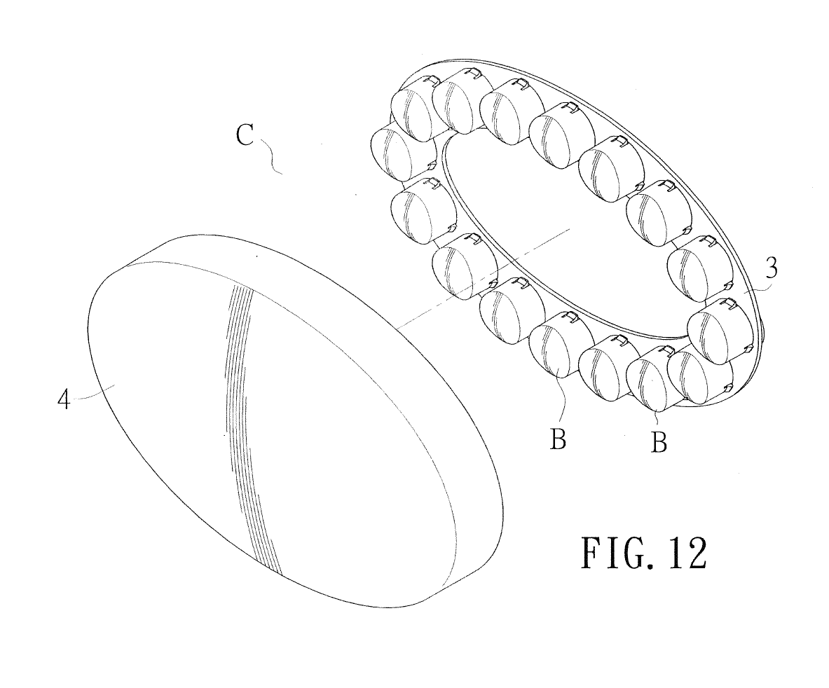

Refer to FIG. 12, a schematic drawing showing the above concentrator module B used in a Lighting Fixture C. The Lighting Fixture C consists of at least one concentrator module B, a substrate 3 for loading the concentrator module B, and a light-transmissive cover 4 arranged on the emission surface of the concentrator module B while the light-transmissive cover 4 is connected to the substrate 3. Thereby the Lighting Fixture C is used as automobile lights for lighting or other lighting devices.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A converging lens with a multiple-curvature compound surface comprising an incident surface and an emission surface; wherein a crest-line along X axis and a crest-line along Y axis are disposed on the emission surface, crossed each other and dividing the emission surface into four curved surface sections, a first curved surface section, a second curved surface section, a third curved surface section and a fourth curved surface section turning in a clockwise direction; the first and the second curved surface sections intersect at the crest-line along X axis while the third and the fourth curved surface sections intersect at the crest-line along X axis; the first and the fourth curved surface sections intersect at the crest-line along Y axis while the second and the third curved surface sections intersect at the crest-line along Y axis; any two points of the crest-line along X axis have the same Y-axis curvature and any two points of the crest-line along Y axis have the same X-axis curvature; the X-axis curvature of each curved surface section is able to be the same or different; the Y-axis curvature of each curved surface section is able to be the same or different.

2. The device as claimed in claim 1, wherein an angle θ is set between an X axis and the crest-line along X axis between the first curved surface section and the second curved surface section of the converging lens; the angle θ ranges from zero degree to thirty degrees,

3. The device as claimed in claim 1, wherein an angle θ is set between an X axis and the crest-line along X axis between the third curved surface section and the fourth curved surface section of the converging lens; the angle θ ranges from zero degree to thirty degrees.

4. A concentrator module comprising at least one converging lens with a multiple-curvature compound surface, and at least one point light source arranged on one side of the converging lens with an incident surface; wherein the converging lens with a multiple-curvature compound surface includes the incident surface and an emission surface; a crest-line along X axis and a crest-line along Y axis are disposed on the emission surface, crossed each other and dividing the emission surface into four curved surface sections, a first curved surface section, a second curved surface section, a third curved surface section and a fourth curved surface section turning in a clockwise direction; the first and the second curved surface sections intersect at the crest-line along X axis while the third and the fourth curved surface sections intersect at the crest-line along X axis; the first and the fourth curved surface sections intersect at the crest-line along Y axis while the second and the third curved surface sections intersect at the crest-line along Y axis; any two points of the crest-line along X axis have the same Y-axis curvature and any two points of the crest-line along Y axis have the same X-axis curvature; the X-axis curvature of each curved surface section is able to be the same or different; the Y-axis curvature of each curved surface section is able to be the same or different.

5. The device as claimed in claim 4, wherein an angle θ is set between an X axis and the crest-line along X axis between the first curved surface section and the second curved surface section of the converging lens; the angle θ ranges from zero degree to thirty degrees.

6. The device as claimed in claim 4, wherein an angle θ is set between an X axis and the crest-line along X axis between the third curved surface section and the fourth curved surface section of the converging lens; the angle θ ranges from zero degree to thirty degrees.

7. A lighting fixture comprising at least one concentrator module, at least one substrate for being assembled with the concentrator module, and at least one light-transmissive cover disposed on one side of the concentrator module with an emission surface and the light-transmissive cover is connected to the substrate; wherein the concentrator module comprising at least one converging lens with a multiple-curvature compound surface, and at least one point light source arranged on one side of the converging lens with an incident surface; the converging lens with a multiple-curvature compound surface includes the incident surface and an emission surface; a crest-line along X axis and a crest-line along Y axis are disposed on the emission surface, crossed each other and dividing the emission surface into four curved surface sections, a first curved surface section, a second curved surface section, a third curved surface section and a fourth curved surface section turning in a clockwise direction; the first and the second curved surface sections intersect at the crest-line along X axis while the third and the fourth curved surface sections intersect at the crest-line along X axis; the first and the fourth curved surface sections intersect at the crest-line along Y axis while the second and the third curved surface sections intersect at the crest-line along Y axis; any two points of the crest-line along X axis have the same Y-axis curvature and any two points of the crest-line along Y axis have the same X-axis curvature; the X-axis curvature of each curved surface section is able to be the same or different; the Y-axis curvature of each curved surface section is able to be the same or different.

8. The device as claimed in claim 7, wherein an angle θ is set between an X axis and the crest-line along X axis between the first curved surface section and the second curved surface section of the converging lens; the angle θ, ranges from zero degree to thirty degrees.

9. The device as claimed in claim 7, wherein an angle θ is set between an X axis and the crest-line along X axis between the third curved surface section and the fourth curved surface section of the converging lens; the angle θ ranges from zero degree to thirty degrees.
